(19) United States
(12) Patent Application Publication
(10) Pub. No.: US 2017/0039875 A1
(43) Pub. Date: Feb. 9, 2017

(54) SITUATIONAL RESPONSE OPTIMIZATION SPACE

(71) Applicant: J. J. Keller & Associates, Inc., Neenah, WI (US)

(72) Inventors: Brian Kubiak, Neenah, WI (US); Joel Landsverk, Appleton, WI (US); Carol O'Hern, Sturgeon Bay, WI (US)

(21) Appl. No.: 14/818,741

(22) Filed: Aug. 5, 2015

(51) Int. Cl. G09B 19/00

(52) U.S. Cl. CPC G09B 19/00

(57) ABSTRACT

A method of reinforcing training including training a person on a subject matter related to a task in which the task includes one or more occurrences to be performed in the future, providing a prompt during training in which the prompt is adapted to form an association with the subject matter of the training, and allowing at least one day to pass between the training and the performance of one of the occurrences of the task. The method further includes providing the prompt in a situational response optimization space where the situational response optimization space immediately precedes the performance of one of the occurrences of the task in time and space, and wherein the prompt triggers the association with the subject matter of the training to aid the person recall subject matter presented during the training while performing the task.

### BACKGROUND

The present invention relates to a method of reinforcing training, and in particular, a method of reinforcing safety training.

It is well known that people have difficultly retaining information they are taught. Studies have shown that the retention rate of information learned drops dramatically even within the first few days. According to the Ebbinghaus Forgetting Curve published by Training Industries, a person only retains 58% of the information they were taught within the first 20 minutes, 33% within 1 day, and 21% within 31 days.

Additionally, the mode of communication used to convey the information affects a person's ability to retain information. Generally speaking, people tend to have better learning retention when the information is conveyed visually. According to the Edgar Dale Cone of Learning, a person retains 10% of what they read, 20% of what they hear, and 30% of what they see. If a person is able to both hear and see the information, the retention rate is improved, reaching about 50%. A person's retention rate is further improved if they are able to actively participate in the learning. For example, simply verbalizing the information learned, or taking part in a conversation will increase a person's retention rate to 70%. The highest retention rate (90%) is achieved when a person is able to both verbalize and take part in the actual activity.

### SUMMARY

In one embodiment, the invention provides a method of reinforcing training including training a person on a subject matter related to a task in which the task includes one or more occurrences to be performed in the future, providing a prompt during training in which the prompt is adapted to form an association with the subject matter of the training, and allowing at least one day to pass between the training and the performance of one of the occurrences of the task. The method further includes providing the prompt in a situational response optimization space where the situational response optimization space immediately precedes the performance of one of the occurrences of the task in time and space, and wherein the prompt triggers the association with the subject matter of the training to aid the person in recalling subject matter presented during the training while performing the task.

In another embodiment, the invention provides a method of reinforcing workplace safety training including training a person on a subject matter related to a task, in which the task includes one or more occurrences to be performed in the future, providing a language-free visual cue during training, in which the visual cue is adapted to form an association with the subject matter of the training, and allowing at least one day to pass between the training and the performance of one of the occurrences of the task. The method further includes providing the visual cue in a situational response optimization space where the situational response optimization space immediately preceding the performance of one of the occurrences of the task in time and space, wherein the visual cue triggers the association with the subject matter of the training to help the person recall subject matter presented during the training.

In another embodiment, the invention provides a method of reinforcing workplace safety training including training a person on workplace safety subject matter related to a task where the task includes one or more occurrences to be performed in the future, allowing at least one day to pass between the training and the performance of one of the occurrences of the task, and providing a prompt in a situational response optimization space, in which the situational response optimization space immediately precedes the performance of one of the occurrences of the task in time and space, and wherein the prompt triggers an association with the workplace safety subject matter of the training and to aid the person recall subject matter presented during the training.

In another embodiment, the invention provides a method of delivering workplace safety training including creating training materials on workplace safety subject matter related to a task where the task includes one or more occurrences to be performed in the future, creating prompts to be used during training where the prompts are adapted to form an association with the subject matter of the training, and creating prompts to be used in a situational response optimization space, in which the situational response optimization space immediately preceding the performance of one of the occurrences of the task in time and space.

In another embodiment, the invention provides a method of delivering workplace safety training including identifying the location of a person, identifying a task affiliated with the location of the person, and determining whether the person has received workplace safety training related to the task. The method further includes notifying the person that training is required prior to performing the task if the person has not received training related to the task, and providing on the spot workplace safety training related to the task prior to the person performing the task.

In another embodiment, the invention provides a method of delivering workplace safety training including creating a badge adapted to communicate a position of a person and a task affiliated with the position of the person, creating a database program in communication with the badge, the database program adapted to determine whether the person has received training related to the task and notify the person if training is required prior to performing the task, and creating a cellular phone application adapted to provide on the spot training to the person prior to the person performing the task.

Other aspects of the invention will become apparent by consideration of the detailed description and accompanying drawings.

### BRIEF DESCRIPTION OF THE DRAWINGS

FIG. 1 is a flow chart of one embodiment of the present invention.

FIG. 2 is a flow chart of another embodiment of the present invention.

FIG. 3 is a flow chart of another embodiment of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items.

In the time between training a person how to perform an activity and the occurrence of the activity, learning is widely known to decline at a rapid rate. While repeated training has shown better retention, it is not always feasible to repeat the training at regular intervals or with the frequency that would be desired to improve retention. The present invention provides a method of improving the retention rate of information learned during behavior-focused training (i.e. training related to an activity or task). Specifically, the invention provides a method of reinforcing information learned during a training process by delivering specific material to a person within a Situational Response Optimization Space (SROS). The SROS is positioned immediately prior to an activity in both time and space. The method enhances training and other communication delivery by prompting reminders immediately preceding the activity. Because the application of learning in a real world situation has proven to be the most effective teaching method, the delivery of specific materials, such as prompts, proximate the time and place of the activity may provide an increased learning retention after the activity. The delivery of prompts within the SROS has some similar aspects to the application of learning during a real world situation.

The SROS refers to the time and space immediately preceding an occurrence of an activity learned during the behavior-focused training or the environment in which the activity is based. The SROS is located at a distance from the activity so that the prompt is received prior to the activity rather than during the execution and location the activity. This enables the prompt to trigger an association with the subject matter of the training before the activity begins. This placement of the prompts also ensures that SROS prompts do not conflict with or distract from other instructions or signs presented during or at the location of the activity.

The SROS prompts can include a visual cue, an audible cue, the vibration of a cell phone, a video clip, a text message, and a combination thereof or like prompts. For example, a visual cue can include simplistic graphics or images depicting an element of the training. An audible cue can be a beep or a voice providing a reminder or warning related to the training. A video prompt can show a short clip of a person exercising the procedure taught during the training. A text message can include a phrase or instruction reminding the trainee of the information provided during the training. The prompts are intended to be simple and engaging. Prompts grab the attention of the trainee and quickly trigger an association with the subject matter of the training. Additionally, prompts can include scannable codes such as quick response codes (QR codes), which are linked directly to training materials or a review of training materials already provided. This will be described in further detail below.

This method can be executed in a variety of circumstances. For example, SROS training can be used in conjunction with workplace safety training including, but not limited to, employees operating heavy machinery, truck drivers, construction workers, teachers and child care providers, or people working with dangerous chemicals. SROS training may improve learning by children or mentally challenged students. SROS training is useful in circumstances where a person's environment changes frequently. For example, a consultant or engineer may be required to visit different sites on a regular basis for evaluation or repair. The method will enable a person to recall the training they previously learned and associate it with a new environment by receiving SROS prompts. Similarly, SROS training can improve the training process of employers who experience a large amount of employee turnover or those who employ temporary employees that are regularly changing. In some embodiments, the method can be used to train a person on behavior goals or tailoring certain behavioral traits. For example, prompts can be used to trigger desired responses, such as choosing healthy eating or sleeping options.

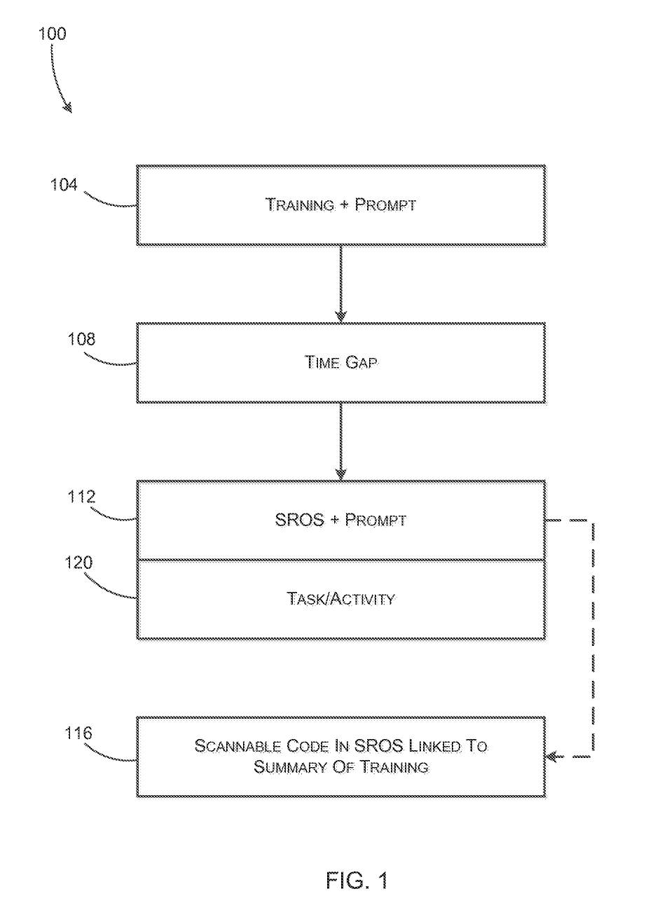

FIG. 1 depicts a flow chart of a method 100 of delivering training according to one embodiment of the invention. The behavior-focused training is designed to instruct trainee how to perform an activity or a task (step 104). The trainee may be an employee who is required to undergo workplace safety training. During the training process, a prompt related to the subject matter of the training is delivered to the trainee (step 104). The prompt can include a visual cue, an audio cue, the vibration of a cell phone, a video, or a text message. The prompt can be delivered to the trainee in a number of ways and can be provided passively or actively. If the prompt is provided passively, an instructor will not necessarily point out or explain the prompt as it is delivered. For example, prompts may appear on the training materials near the description of how to perform each task. In this example, there may be a graphical image of a person wearing safety goggles just above the instructions on when to wear safety goggles. If the prompt is actively provided, the instructor may draw attention to the prompt or may require the trainee to use the prompt in an exercise. For example, the trainee may be required to match the visual or audio cue with an element of the training.

After training is complete, there will often be a gap in time before the trainee performs the task learned during training (step 108). As described in the background section, a person generally forgets 67% of what they learned after the first day, retaining only 33% of the information. This means that if a new employee is provided with workplace safety training one day before performing the task, the employee will forget the majority of the training prior to the first occurrence of the task. There may be additional gaps in time between occurrences of the task. Some tasks may only occur weekly or monthly. Therefore, the gap in time may be prior to the first occurrence of the task or the gap may fall between training and a later occurrence of the task (step 108).

In order to compensate for some of the forgetting that occurs during the gap in time, a prompt is delivered to the trainee within the Situational Response Optimization Space (step 112). The SROS creates an opportunity to aid the trainee in recalling information learned during training. Because the SROS is positioned immediately prior to the performance of the task (step 120) in time and space, the SROS offers a window for the trainee to recall the information learned before engaging in the task. In certain contexts, the timing and space of the SROS is particularly beneficial. For example, when SROS training is provided in the context of workplace safety, there is a significant benefit in triggering the recall of training prior to the employee engaging in unsafe tasks. The employee is equipped with the information prior to being placed in an unpredictable or unsafe situation. Likewise, the SROS is beneficial to tasks that require a large amount of communication during the activity because the trainee is not required to recall training information while also communicating with others during the task.

In addition, delivering the prompt immediately preceding the activity or the environment in which the activity is based ensures that the prompt will not interfere with other instructions or signals provided during training. For example, the prompt is delivered in an area spaced apart from an area containing regulatory safety signs so as not to confuse the regulatory signs with the training prompts. In instances where the prompt includes visual cues, such as signage, it may be important to have spacial separation between the training prompts and the mandatory safety signage. In other instances where the prompts include video or audio cues it may be important to avoid distracting the trainee from the mandatory signage.

Regardless of the type of prompt provided to the trainee, the prompt is presented during a SROS (step 112). The prompt can include any of the types of prompts previously mentioned including visual cues, audio cues, text messages, vibrations, and the like. The prompt will trigger an affiliation with the training by reminding the trainee of the prompt the trainee experienced during training. This will, in turn, remind the trainee of the subject matter learned in connection with the prompt. In some instances the prompt may be non-substantive, such as a generic beep. In this case, the beep aids in triggering an association with the training simply through repetition and the association of the same prompt being provided both in training and in action. In other instances the prompt will be substantive, using words, phrases, images or videos that depict aspects of the training. In this case, the prompt provides additional contexts clues to the trainee, which will aid in the recall process.

The following are some examples of how a prompt may be delivered within the SROS, which are provided for exemplary purposes only. In one example embodiment, an automated voice recites short phrases to trigger an association with the subject matter of the training. In this example, the voice can be heard in the SROS, such as a hallway just outside of the environment where the task is to be performed. Another example embodiment could include placing stylized graphical signage near a cabinet where a truck driver would pick up keys to a truck. In this example, the key cabinet would be within the SROS and the parking lot where the truck is park would be considered the environment where the task is based. In another embodiment, a text message may be sent to a construction worker as they approach a construction site. The text message can be specifically tailored to trigger training related to safety procedures of that particularly construction site. Prompts can also be used to elicit a certain behavior that was learned during a behavior-focused training. For example, a text message containing an image of a healthy eating option may be sent to the trainee within the SROS to remind the person to avoid unhealthy eating options. In this example, the SROS may be at a time just prior to a typical meal time, or it may be the physical space just outside a lunch

Prompts delivered within the SROS can be accompanied by scannable codes or electronic links positioned proximate the prompt (step 116). The scannable codes can include bar codes or QR codes that can be scanned by a cell phone or other capable device to link the trainee to a summary of the training material. In some instances, a cell phone or other scanning device may be capable of scanning a visual prompt or image directly. For example, the phone may have image recognition of the visual prompt itself, without the use of a bar code. The summary can be provided through an on-line service of cellular phone application. When the trainee notices the prompt but cannot recall enough of the information learned during training, the trainee can choose to scan the code to obtain additional information to aid in training recall (step 116). This step is optional and may not be included in every embodiment. Once the trainee has refreshed their memory on the training, they can perform the task or activity (step 120).

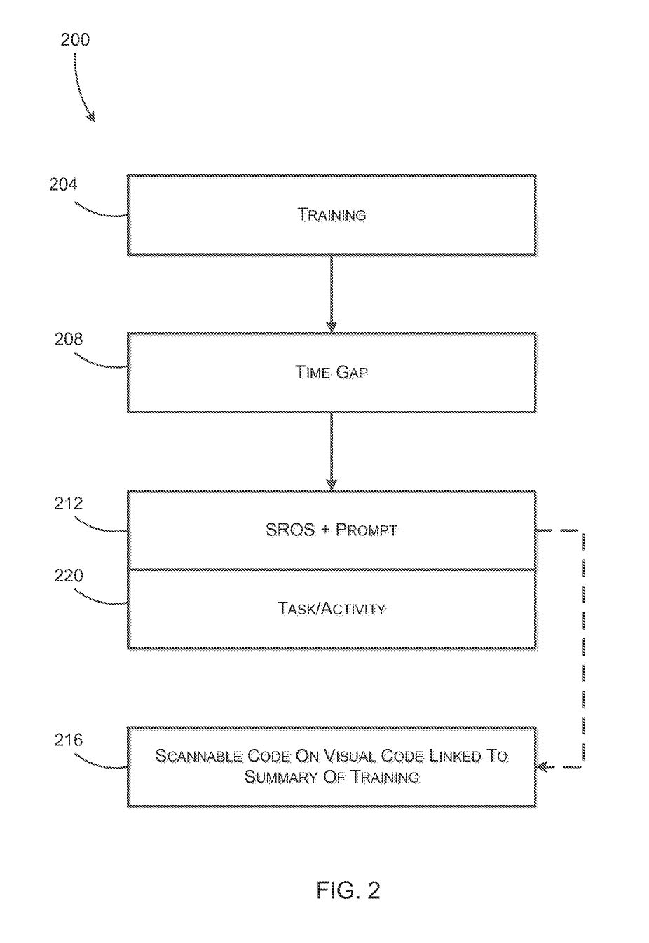

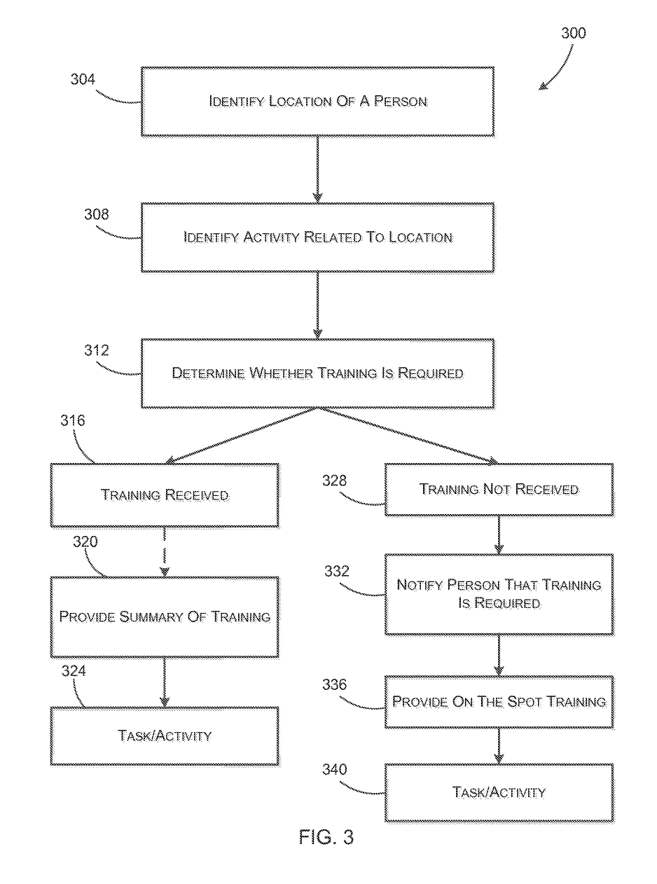

The embodiments of FIG. 2 and FIG. 3 have similarities to the method 100 of FIG. 1. Therefore, components or features described with respect to only one or some of the embodiments described herein are equally applicable to any other embodiment described herein. FIG. 2 depicts a flow chart of a method 200 of reinforcing training according to another embodiment of the invention. The method 200 includes training on a subject matter related to a particular task or activity. In this embodiment, the training is conducted without the use of prompts (step 204). Training may be provided by a third party that is not affiliated with the delivery of prompts to be used within the SROS. Training may be conducted at a different location than the location where the task is to be performed or at the same location of the task. Training is followed by a gap in time before the trainee engages in the task (step 208). This gap may be present before the first occurrence of the task or may be present before a later occurrence of the task.

Immediately before the trainee engages in an occurrence of the task, a prompt is delivered to the trainee to trigger an association with the training (step 212). In this embodiment, the prompt is not affiliated with a prompt that was previously presented during training. Rather, the prompt is directly affiliated with the subject matter of the training. In this case, substantive prompts are used since non-substantive prompts will not create a link to the subject matter of the training. Similar to the embodiment of FIG. 1, the prompts may be accompanied by scannable codes that provide information related to the subject matter of the training (step 216). Once the trainee recalls information learned during the training process, the trainee will perform the task (step 220).

FIG. 3 provides a flow chart of a method 300 of delivering training according to another embodiment of the invention. In the previous embodiments, a prompt was delivered within the SROS to trigger an association with a training that the trainee previously received. In some instances, a person may not be trained yet, or may unknowingly wander into an area affiliated with a task that the person has not received training on. FIG. 3 illustrates a method of providing on the spot training when a person has not received training.

The method 300 includes identifying the location of a person (step 304). The person may be an employee wearing a tracking device, such as a GPS capable badge. Alternatively, the employee may be equipped with a cell phone or a radio transceiver (e.g. walky talky) that is capable of transmitting a location. Identifying the person's location can include continuous GPS tracking or can include identifying when the person enters a SROS.

Once the person is identified as being proximate to or within a SROS, the method 300 includes identifying an activity or task affiliated with that particular location (step 308). The method further includes determining whether training is required or recommended prior to engaging in the activity (step 312). If training is required then it is determined whether the person has already received the training (step 316) or whether the person is in need of training (step 324). This determination can be made by utilizing a database containing information about which activities required training, the location of each activity, and which employees have received training on each activity. If the person has received the appropriate training (step 316), the person has the option of scanning a code to received additional information or a summary of the training as a refreshers (320). Once the person recalls the training, the person can perform the task (324).

If the person is in need of training prior to engaging in the activity (step 328), a notification is delivered to the person (step 332). The notification is similar to a prompt in that the notification is delivered within the SROS and can take on the same form as a prompt including an audio cue, visual cue, video clip, text message, vibration, etc. The notifications do not replace the prompts, but rather, the notifications and the prompts work in conjunction with one another. Notifications and prompts are both delivered within the SROS and can sometimes be combined. For example, if a graphical sign is used as a prompt, the sign can include a notification device, such as a light that flashes red when the person has not received training. The notification informs the person that they have not received training and cannot engage in the activity until training is complete (step 332).

According to one embodiment of the method 300, when training is required before proceeding with the task, the person will have access to on the spot training (step 336). On the spot training can be provided through a number of methods. For example, a scannable code may be provided within the SROS that links the person to an on-line training that can be accessed on a cell phone. The scannable code can be positioned on a visual prompt. In another example, a text message can be delivered to the person to provide step by step instructions on how to perform the task. Alternatively video clip can be played on a screen within the SROS. After on the spot training is complete, the person can proceed with the task (step 340).

Thus, embodiments of the invention provide, among other things, systems and methods for delivering training and reinforcing training. These systems and methods can be used to provide workplace safety training, among other behavior-focused training.

Although the invention has been described with reference to certain preferred embodiments, variations and modifications exit within the spirit and scope of the present invention. Various features and advantages of the invention are set forth in the following claims.

1. A method of reinforcing training, the method comprising:
training a person on a subject matter related to a task, the task including one or more occurrences to be performed in the future;
providing a prompt during training, the prompt adapted to form an association with the subject matter of the training; and
providing the prompt in a situational response optimization space, the situational response optimization space immediately preceding the performance of one of the occurrences of the task in time and space,
wherein the prompt triggers the association with the subject matter of the training to aid the person recall subject matter presented during the training while performing the task.

2. The method of claim 1, wherein the prompt includes at least one from the following list:
an image, an audible cue, a vibration, a video, or a text message.

3. The method of claim 1, wherein the training is related to safety workplace safety.

4. The method claim 1, wherein the prompt provided in the situational response optimization space precedes mandatory safety signage.

5. The method of claim 1, further including providing one of a scannable code and an image in the situational response optimization space electronically linked to a summary of the subject matter presented at the training.

6. A method of reinforcing workplace safety training, the method comprising:
training a person on a subject matter related to a task, the task including one or more occurrences to be performed in the future;
providing a language-free visual cue during training, the visual cue adapted to form an association with the subject matter of the training;
allowing time to pass between the training and the performance of one of the occurrences of the task; and
providing the visual cue in a situational response optimization space, the situational response optimization space immediately preceding the performance of one of the occurrences of the task in time and space,
wherein the visual cue triggers the association with the subject matter of the training to help the person recall subject matter presented during the training.

7. The method claim 6, wherein the visual cue provided in the situational response optimization space precedes mandatory safety signage.

8. The method of claim 6, further including providing a scannable code on the visual cue provided in the situational response optimization space, the scannable code electronically linked to a summary of the subject matter presented at the training.

9. A method of reinforcing safety training, the method comprising:
training a person on safety subject matter related to a task, the task including one or more occurrences to be performed in the future;
allowing at least a one day to pass between the training and the performance of one of the occurrences of the task; and
providing a prompt in a situational response optimization space, the situational response optimization space immediately preceding the performance of one of the occurrences of the task in time and space,
wherein the prompt triggers an association with the safety subject matter of the training and to aid the person recall subject matter presented during the training.

10. The method of claim 9, wherein the prompt includes at least one from the following list:
an image, an audible cue, a vibration, a video, a text message.

11. The method claim 9, wherein the prompt provided in the situational response optimization space precedes mandatory safety signage.

12. The method of claim 9, further including providing at least one of a scannable code and an image in the situational response optimization space electronically linked to a summary of the subject matter presented at the training.

13. A method of delivering workplace training, the method comprising:
creating training materials on subject matter related to a workplace task, the task including one or more occurrences to be performed in the future;
creating prompts to be used during training, the prompts adapted to form an association with the subject matter of the training; and
creating prompts to be used in a situational response optimization space, the situational response optimization space immediately preceding the performance of one of the occurrences of the task in time and space.

14. The method of claim 13, wherein the prompt includes at least one from the following list:
an image, an audible cue, a vibration, a video, a text message.

15. The method claim 13, wherein the prompt provided in the situational response optimization space precedes mandatory safety signage.

16. The method of claim 13, further including providing at least one of a scannable code and an image located on the prompt to be used in the situational response optimization space and configuring the code or image to provide a summary of the subject matter presented during the training when the code or image is electronically scanned.

17. A method of delivering training, the method comprising:
identifying the location of a person;
identifying a task affiliated with the location of the person;
determining whether the person has received training related to the task; notifying the person that training is required prior to performing the task if the person has not received training related to the task, and
providing on the spot training related to the task prior to the person performing the task.

18. The method of claim 17, including providing at least one of a badge and a cellular phone application adapted to wirelessly transmit the location of the person.

19. The method claim 18, wherein notifying the person that training is required includes wirelessly sending a signal to at least one of the badge and the cellular phone application to produce at least one of a vibration and an audible sound.

20. The method of claim 19, wherein providing on the spot training includes presenting training through a cellular phone application.

21. The method of claim 20, further including providing at least one of a scannable code and an image proximate the location of the task to be performed, the code or image adapted to be scanned by a cell phone to initiate the training presented through the cellular phone application.

22. A method of delivering training, the method comprising:
creating a badge adapted to communicate a position of a person and a task affiliated with the position of the person;
creating a database program in communication with the badge, the database program adapted to determine whether the person has received training related to the task and notify the person if training is required prior to performing the task; and
creating a cellular phone application adapted to provide on the spot training to the person prior to the person performing the task.

23. The method of claim 22, wherein notifying the person that training is required includes wirelessly sending a signal to at least one of the badge and the cellular phone application to produce at least one of a vibration and an audible sound.

24. The method of claim 22, wherein on the spot training includes at least one of a training video, an audible training, and a written training provided through a cellular phone application.

25. The method of claim 22, further including providing at least one of a scannable code and an image to be placed proximate the location of the task to be performed, the code or image adapted to be scanned by a cell phone to initiate the training presented through the cellular phone application.
